(19) United States
(12) Patent Application Publication
(10) Pub. No.: US 2017/0163199 A1
(43) Pub. Date: Jun. 8, 2017

(54) DEVICE FOR CONTROLLING A MOTOR

(71) Applicants: Hyundai Motor Company, Seoul (KR); KIA Motors Corporation, Seoul (KR); Myunghwa Ind. Co., Ltd., Seoul (KR)

(72) Inventors: Jung Hoon PARK, Anyang-si (KR); Kyounghee KIM, Ansan-si (KR); Jae Man CHO, Seoul (KR); Tae Sung OH, Ansan-si (KR); Geun Oh DONG, Hwaseong-si (KR)

(73) Assignees: Hyundai Motor Company, Seoul (KR); KIA Motors Corporation, Seoul (KR); Myunghwa Ind. Co., Ltd., Seoul (KR)

(21) Appl. No.: 15/216,845

(22) Filed: Jul. 22, 2016

(30) Foreign Application Priority Data
Dec. 8, 2015 (KR) 10-2015-0174146

(51) Int. Cl. H02P 27/08; F01P 3/20; F01P 5/12; H02P 6/182; H02P 21/22

(52) U.S. Cl. CPC H02P 27/08; H02P 6/182; H02P 21/22; F01P 5/12; F01P 3/20; F01P 2037/00

(57) ABSTRACT

A device for controlling a motor includes an inverter which drives the motor, a first shunt resistor which is connected to a source of a first low-side transistor included in the inverter, a second shunt resistor which is connected to a source of a second low-side transistor included in the inverter, and a controller which controls the inverter based on a first current flowing through the first shunt resistor and a second current flowing through the second shunt resistor.

### CROSS-REFERENCE TO RELATED APPLICATION

The present application claims priority to and the benefit of Korean Patent Application No. 10-2015-0174146, filed in the Korean Intellectual Property Office on Dec. 8, 2015, the entire contents of which are incorporated herein by reference.

### BACKGROUND

(a) Field of the Disclosure

The present disclosure relates to a water pump, and more particularly, to a device for controlling a motor included in the water pump.

(b) Description of the Related Art

Generally, a water pump circulates coolant to an engine (or a vehicle engine) and a heater in order to cool the engine and heat a cabin. The coolant flowing out from the water pump circulates through and exchanges heat with the engine, the heater, or a radiator, and flows back in the water pump. Such a water pump is largely divided into a mechanical water pump and an electric water pump.

The mechanical water pump is connected to a pulley fixed to a crankshaft of the engine and is driven according to rotation of the crankshaft (i.e., rotation of the engine). Therefore, the coolant amount flowing out from the mechanical water pump is determined according to rotation speed of the engine. However, the coolant amount required in the heater and the radiator is a specific value regardless of the rotation speed of the engine. Therefore, the heater and the radiator do not operate normally in a region where the engine speed is slow, and in order to operate the heater and the radiator normally, the engine speed must be increased. However, if the engine speed is increased, fuel consumption of a vehicle also increases.

On the contrary, the electric water pump is driven by a motor controlled by a control apparatus. Therefore, the electric water pump can determine the coolant amount regardless of the rotation speed of the engine. Since components used in the electric water pump, however, are electrically operated, it is important for electrically operated components to have sufficient waterproof performance. If the components have sufficient waterproof performance, performance and durability of the electric water pump may also improve.

Currently, the number of vehicles having an electric water pump is tending to increase. Accordingly, various technologies for improving performance and durability of the electric water pump are being developed.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide a device for controlling a motor which is capable of using at least two shunt resistors to control the motor.

An exemplary form of the present disclosure may provide the device for controlling the motor, including: an inverter which drives the motor; a first shunt resistor which is connected to a source of a first low-side transistor included in the inverter; a second shunt resistor which is connected to a source of a second low-side transistor included in the inverter; and a controller which controls the inverter based on a first current flowing through the first shunt resistor and a second current flowing through the second shunt resistor.

The controller may use the first current and the second current to estimate a position of a rotor included in the motor, may differentiate a change in the position to detect a speed of the motor, may compares the detected speed of the motor with a target speed of the motor to get speed deviation and calculate a 3-phase voltage vector corresponding to the speed deviation, and may provide a pulse width modulation (PWM) signal corresponding to the calculated 3-phase voltage vector to the inverter.

Another exemplary form of the present disclosure may provide the device for controlling the motor, including: an inverter which drives the motor; a first shunt resistor which is connected to a source of a first low-side transistor included in the inverter; a second shunt resistor which is connected to a source of a second low-side transistor included in the inverter; a third shunt resistor which is connected to a source of a third low-side transistor included in the inverter; and a controller which controls the inverter based on a first current flowing through the first shunt resistor, a second current flowing through the second shunt resistor, and a third current flowing through the third shunt resistor.

The controller may use the first current and the second current and the third current to estimate a position of a rotor included in the motor, may differentiate a change in the position to detect a speed of the motor, compares the detected speed of the motor with a target speed of the motor to get speed deviation and calculate a 3-phase voltage vector corresponding to the speed deviation, and may provide a pulse width modulation (PWM) signal corresponding to the calculated 3-phase voltage vector to the inverter.

The controller may detect disconnection in a stator coil included in the motor or an open-circuit state of a circuit including the first shunt resistor and the second shunt resistor and the third shunt resistor based on the first current, the second current, and the third current.

When one of the first current, the second current, and the third current is not detected by being detected that a duty cycle of a pulse width modulation (PWM) signal corresponding to one of the first current, the second current, and the third current is greater than or equal to a threshold value, the controller may use Kirchhoff equation to calculate the current that is not detected.

The device for controlling the motor according to the exemplary form of the present disclosure may use two shunt resistors to perform sensorless vector control over a motor such as a brushless alternating current (BLAC) motor or use three shunt resistors to perform sensorless vector control over the BLAC motor.

In sensorless vector control using back electromotive force (EMF) voltage according to related art, minimum driving speed (or minimum rotation speed) of the motor is 1/7.5 revolutions per minute (RPM) of a rated motor speed. However, the embodiment of the present invention may operate (or drive) the motor at a low speed that is 1/40 RPM of the rated motor speed.

The form of the present disclosure may drive the motor at a maximum torque in overload time of the motor, and thus the form of the present disclosure increases efficiency of the motor when the motor operates in the overload time.

Even In a state in which concentration of a coolant (e.g., a Long Life Coolant) is low but viscosity of the coolant is high because of an extremely low temperature, the form of the disclosure may easily drive the motor included in an electric water pump (EWP) that is used for cooling an engine.

Forms of the present disclosure may use a three-phase current of the motor to realize a coil open logic for determining disconnection of a stator coil included in the motor.

Further, the form of the disclosure may control a phase current supplied to the motor to perform supersaturation driving for the motor. The supersaturation driving may be to supply a maximum value of the phase current to the motor. Accordingly, output of the motor may be controlled to increase up to 107% of a rated output.

### BRIEF DESCRIPTION OF THE DRAWINGS

A brief description of the drawings will be provided to more sufficiently understand the drawings which are used in the detailed description of the present disclosure.

FIG. 1 is a view representing an example of a control method for a motor using a back electromotive force (EMF) voltage.

FIG. 2 is a view for explaining a device for controlling a motor according to one exemplary form of the present disclosure.

FIG. 3 is a view describing a device for controlling a motor according to another exemplary form of the present disclosure.

### DETAILED DESCRIPTION

In order to sufficiently understand the present disclosure and the object achieved by forms of the present disclosure, the accompanying drawings illustrating exemplary form of the present disclosure and contents described in the accompanying drawings are to be referenced.

Hereinafter, the present disclosure will be described in detail by describing exemplary forms of the present disclosure with reference to the accompanying drawings. In describing the present disclosure, well-known configurations or functions will not be described in detail since they may unnecessarily obscure the gist of the present disclosure. Throughout the accompanying drawings, the same reference numerals will be used to denote the same components.

Terms used in the present specification are only used in order to describe specific exemplary forms rather than limiting the present disclosure. Singular forms are to include plural forms unless the context clearly indicates otherwise. It will be further understood that the terms “include” or “have” used in the present specification specify the presence of features, numerals, steps, operations, components, or parts mentioned in the present specification, or a combination thereof, but do not preclude the presence or addition of one or more other features, numerals, steps, operations, components, parts, or a combination thereof.

Throughout this specification and the claims that follow, when it is described that an element is “coupled” to another element, the element may be “directly coupled” to the other element or “electrically or mechanically coupled” to the other element through a third element.

Unless defined otherwise, it is to be understood that the terms used in the present specification including technical and scientific terms have the same meanings as those that are generally understood by those skilled in the art. It must be understood that the terms defined by the dictionary have identical meanings within the context of the related art, and they should not be ideally or excessively formally defined unless the context clearly dictates otherwise.

For fuel efficiency improvement of an engine, heating using heat storage of the engine in electric vehicle (EV) driving mode of a hybrid electric vehicle, and cooling performance improvement of the engine using an exhaust gas recirculation (EGR) device, an electric water pump (EWP) for cooling the engine is used.

The EWP has a configuration combining a common water pump with a high-efficiency permanent magnet motor and a smart controller. The motor included in the EWP may be a three-phase brushless direct current (BLDC) motor, and a control method for the motor is a sensorless control method. In order to improve fuel efficiency of the vehicle, a technique for improving the efficiency of the motor included in the EWP is being developed.

The sensorless control method (or a sensorless vector control method) may be divided into a control method that uses back electromotive force (EMF) voltage and one shunt resistor to perform commutation for a three-phase motor and a control method that detects two phase currents or three phase currents of the motor to control three phase current vectors (or three phase current phasors) of the motor. The back EMF voltage may be a generating voltage generated in a stator coil of the motor when a rotor magnet of the motor rotates.

The back EMF voltage is increased in proportion to rotational force or rotational speed of a rotor included in the motor. Unit of the back EMF voltage may be V/Krpm and the back EMF voltage may be expressed by size of a voltage generated in 1000 RPM. The commutation may be an operation that supplies a voltage to each phase corresponding to three phase stator coils of a brushless direct current (BLDC) motor or a brushless alternating current (BLAC) motor based on a position of the rotor. For example, in the commutation, a plus voltage is applied to an R phase of the three phase coils (A, B, C) when an N-pole magnet of the rotor is positioned on the R phase. Then, the R phase becomes an N-pole so that the R phase pushes the N-pole magnet of the rotor, thereby rotating the motor.

A noise that is due to a torque ripple and occurs in the control method using the back EMF voltage is greater than that in the control method using the current vectors. The control method using the current vectors may improve efficiency of the motor and reduce a noise more than the control method using the back EMF voltage.

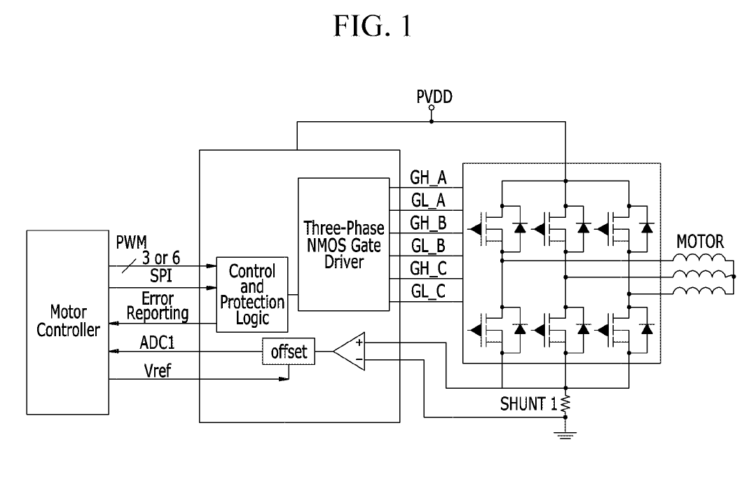

FIG. 1 is a view representing an example of a control method for a motor using a back electromotive force (EMF) voltage.

Referring to FIG. 1, the control method is a method that uses the back electromotive force (EMF) voltage detected from a brushless direct current (BLDC) motor and one shunt resistor to perform commutation (or commutation function) for the motor. The control method uses the back EMF voltage for driving the motor, uses open loop speed control to start the motor and rotate the motor above a certain speed, and converts the open loop speed control to closed loop speed control when the back EMF voltage is detected. Because of this control feature, the minimum drive RPM of the motor should be slightly high.

The shunt resistor (SHUNT 1) shown in FIG. 1 is used for detecting an overcurrent while driving the motor.

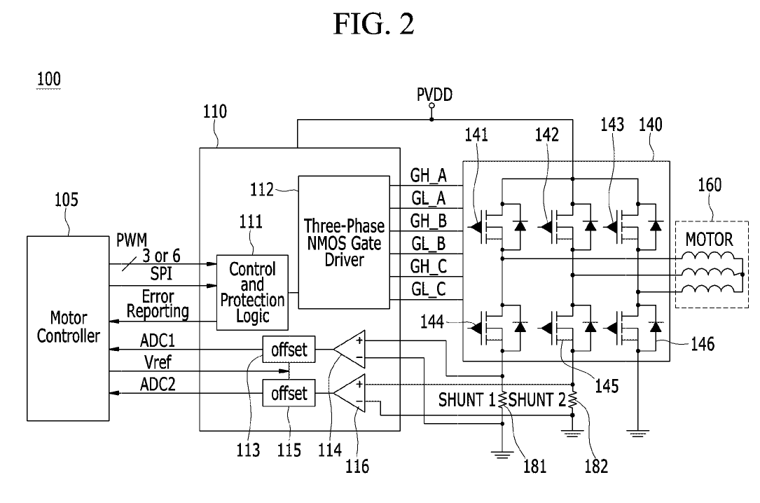

FIG. 2 is a view for explaining a device for controlling a motor according to one exemplary form of the present disclosure.

Referring to FIG. 2, the device 100 for controlling the motor 160 includes a controller (or a motor controller) 105, a driver circuit 110, an inverter 140, a first shunt resistor (SHUNT 1) 181, and a second shunt resistor (SHUNT 2) 182. The device 100 may perform field oriented control that is vector control such as current vector control.

For example, the motor 160 may be a motor included in an electric water pump (EWP) of a vehicle and may be a brushless alternating current (BLAC) motor included in a permanent magnet synchronous motor. The EWP may include the motor 160 and the device 100.

The inverter 140 may drive the motor 160.

The first shunt resistor 181 may be connected to a source (or a first terminal) of a first low-side transistor 144 included in the inverter 140.

The second shunt resistor 182 may be connected to a source of a second low-side transistor 145 included in the inverter 140.

The controller 105 may control the inverter 140 based on a first current flowing through the first shunt resistor 181 and a second current flowing through the second shunt resistor 182.

The controller 105 may use the first current and the second current to estimate a position of a rotor included in the motor 160, may differentiate a change in the position to detect a speed of the motor 160, may compare the detected speed of the motor with a target speed of the motor 160 to get speed deviation and calculate a 3-phase voltage vector corresponding to the speed deviation, and may provide a pulse width modulation (PWM) signal corresponding to the calculated 3-phase voltage vector to the inverter 140.

The controller 105 may provide (or transmit) a pulse width modulation (PWM) signal and an SPI signal to a protection circuit 111 of the driver circuit 110 in response to a first ADC signal (ADC1) and a second ADC signal (ADC2). The PWM signal may be a signal for controlling a drive voltage of the motor. The SPI signal, which is a serial to peripheral interface signal or a serial to parallel interface signal, may be a signal controlling to convert the PWM signal that is a serial signal to a parallel signal.

The controller 105 may control overall operation of the device 100. For example, the controller 105 may be one or more microprocessors operated by a program or hardware including the microprocessor. The program may include a series of commands for executing a method of controlling the motor according to an exemplary embodiment of the present invention.

The driver circuit 110 includes the protection circuit 111, a driver 112, a first offset circuit 113, a first amplifier 114, a second offset circuit 115, and a second amplifier 116.

GH_A that is an output signal of the driver 112 may be a signal that is a gate signal of a metal oxide semiconductor field effect transistor (MOSFET) and is a high side signal of an A phase, and GL_A that is an output signal of the driver 112 may be a signal that is a gate signal of a MOSFET and is a low side signal for the A phase. GH_B that is an output signal of the driver 112 may be a signal that is a gate signal of a metal oxide semiconductor field effect transistor (MOSFET) and is a high side signal of an B phase, and GL_B that is an output signal of the driver 112 may be a signal that is a gate signal of a MOSFET and is a low side signal for the B phase. GH_C that is an output signal of the driver 112 may be a signal that is a gate signal of a metal oxide semiconductor field effect transistor (MOSFET) and is a high side signal of an C phase, and GL_C that is an output signal of the driver 112 may be a signal that is a gate signal of a MOSFET and is a low side signal for the C phase.

The first amplifier 114 may amplify a voltage across the first shunt resistor 181 (or the current flowing through the first shunt resistor 181) to provide the amplified voltage to the first offset circuit 113. For example, the first amplifier 114 may be realized as an operational amplifier (OP-amp), and the first amplifier 114 may also be referred to as a shunt current operational amplifier.

The first offset circuit 113 may output the first ADC signal (ADC1) that is an offset signal (e.g., a difference signal between an output signal of the first amplifier 114 and a reference voltage (Vref)) based on the reference voltage (Vref) that the controller 105 provides to provide the first ADC signal (ADC1) to the controller (105). The first ADC signal, which is an analog-to-digital conversion signal, may a digital signal corresponding to an analog signal which is the output signal of the first amplifier 114.

The second amplifier 116 may amplify a voltage across the second shunt resistor 182 (or the current flowing through the second shunt resistor 182) to provide the amplified voltage to the second offset circuit 115. For example, the second amplifier 116 may be realized as an operational amplifier (OP-amp), and the second amplifier 116 may also be referred to as a shunt current operational amplifier.

The second offset circuit 115 may output the second ADC signal (ADC2) that is an offset signal (e.g., a difference signal between an output signal of the second amplifier 116 and the reference voltage (Vref)) based on the reference voltage (Vref) that the controller 105 provides to provide the second ADC signal (ADC2) to the controller 105. The second ADC signal, which is an analog-to-digital conversion signal, may a digital signal corresponding to an analog signal which is the output signal of the second amplifier 116.

The protection circuit 111 may convert the PWM signal to a parallel signal to provide the converted parallel signal to the driver 112 in response to the PWM signal and the SPI signal. The protection circuit 111 may analyze the PWM signal and the SPI signal to detect an error. When there is the error, the protection circuit 111 may transmit an error signal to the controller 105. In response to the error signal, the controller 105 may transmit a corrected PWM signal and a corrected SPI signal to the protection circuit 111.

In response to the converted parallel signal, the driver 112 may generate the gate signal (GH_A, GL_A, GH_B, GL_B, GH_C, or GL_C) that turns on each of transistors 141, 142, 143, 144, 145, and 146 included in the inverter 140. The inverter 140 may generate an alternating current signal for driving a motor 160 in response to the gate signal.

The inverter 140 may include a plurality of transistors, and may convert a power supply voltage (PVDD) that is a direct current (DC) to an alternating current (AC) voltage. For example, the transistor may be an N-channel metal oxide semiconductor field effect transistor (MOSFET) (i.e., an NMOS transistor) or an insulated gate bipolar transistor (IGBT).

As described above, the device 100 may combine two shunt resistors with the source of a low-side field effect transistor (FET) of the inverter 140 to measure current Ia that is the first current and current Ib that is the second current, thereby estimating the rotor position of the motor 160. Current Ia and current Ib may be included in the motor driving current.

The device 100 may differentiate a change in the rotor position to detect rotational speed of the motor 160, may compare the detected speed of the motor with the target speed of the motor 160 to get speed deviation and calculate the 3-phase voltage vector corresponding to the speed deviation, and may supply a pulse width modulation (PWM) voltage corresponding to the calculated 3-phase voltage vector to the inverter 140, thereby generating the motor phase current flowing through the stator coil of the motor 160 as a sine wave. The motor 160 may be driven by the sine wave.

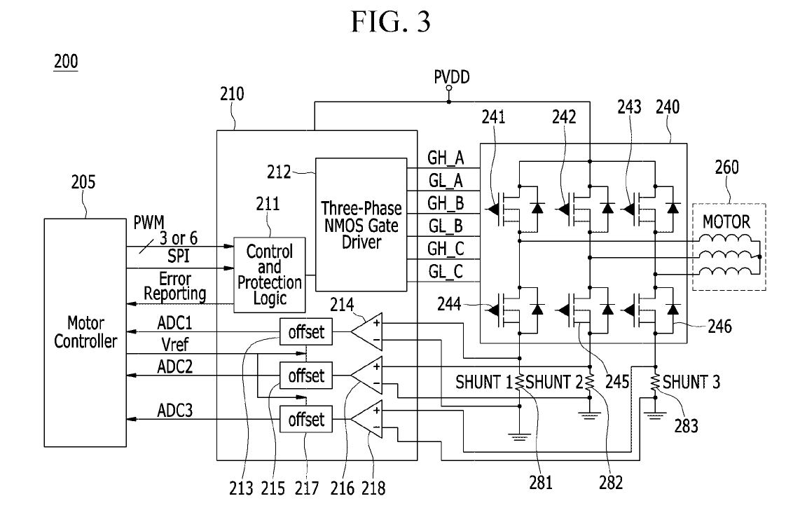

FIG. 3 is a view describing a device for controlling a motor according to another exemplary form of the present disclosure.

Referring to FIG. 3, the device 200 for controlling the motor 260 includes a controller (or a motor controller) 205, a driver circuit 210, an inverter 240, a first shunt resistor (SHUNT 1) 281, a second shunt resistor (SHUNT 2) 282, and a third shunt resistor (SHUNT 3) 283. The device 200 may perform field oriented control that is vector control such as current vector control.

For example, the motor 260 may be a motor included in an electric water pump (EWP) of a vehicle and may be a brushless alternating current (BLAC) motor included in a permanent magnet synchronous motor. The EWP may include the motor 260 and the device 200.

The inverter 240 may drive the motor 260.

The first shunt resistor 281 may be connected to a source (or a first terminal) of a first low-side transistor 244 included in the inverter 240.

The second shunt resistor 282 may be connected to a source of a second low-side transistor 245 included in the inverter 240.

The third shunt resistor 283 may be connected to a source of a third low-side transistor 246 included in the inverter 240.

The controller 205 may control the inverter 240 based on a first current flowing through the first shunt resistor 281, a second current flowing through the second shunt resistor 282, and a third current flowing through the third shunt resistor 283.

The controller 205 may use the first current, the second current, and the third current to estimate a position of a rotor included in the motor 260, may differentiate a change in the position to detect a speed of the motor 260, may compare the detected speed of the motor with a target speed of the motor 260 to get speed deviation and calculate a 3-phase voltage vector corresponding to the speed deviation, and may provide a pulse width modulation (PWM) signal corresponding to the calculated 3-phase voltage vector to the inverter 240.

The controller 205 may provide (or transmit) a pulse width modulation (PWM) signal and an SPI signal to a protection circuit 211 of the driver circuit 210 in response to a first ADC signal (ADC1), a second ADC signal (ADC2), and a third ADC signal (ADC3). The PWM signal may be a signal for controlling a drive voltage of the motor. The SPI signal, which is a serial to peripheral interface signal or a serial to parallel interface signal, may be a signal controlling to convert the PWM signal that is a serial signal to a parallel signal.

The controller 205 may control overall operation of the device 200. For example, the controller 205 may be one or more microprocessors operated by a program or hardware including the microprocessor. The program may include a series of commands for executing a method of controlling the motor according to an exemplary embodiment of the present invention.

The driver circuit 210 includes the protection circuit 211, a driver 212, a first offset circuit 213, a first amplifier 214, a second offset circuit 215, and a second amplifier 216, a third offset circuit 217, and a third amplifier 218.

GH_A that is an output signal of the driver 212 may be a signal that is a gate signal of a metal oxide semiconductor field effect transistor (MOSFET) and is a high side signal of an A phase, and GL_A that is an output signal of the driver 212 may be a signal that is a gate signal of a MOSFET and is a low side signal for the A phase. GH_B that is an output signal of the driver 212 may be a signal that is a gate signal of a metal oxide semiconductor field effect transistor (MOSFET) and is a high side signal of an B phase, and GL_B that is an output signal of the driver 212 may be a signal that is a gate signal of a MOSFET and is a low side signal for the B phase. GH_C that is an output signal of the driver 212 may be a signal that is a gate signal of a metal oxide semiconductor field effect transistor (MOSFET) and is a high side signal of an C phase, and GL_C that is an output signal of the driver 212 may be a signal that is a gate signal of a MOSFET and is a low side signal for the C phase.

The first amplifier 214 may amplify a voltage across the first shunt resistor 281 (or the current flowing through the first shunt resistor 281) to provide the amplified voltage to the first offset circuit 213. For example, the first amplifier 214 may be realized as an operational amplifier (OP-amp), and the first amplifier 214 may also be referred to as a shunt current operational amplifier. The first offset circuit 213 may output the first ADC signal (ADC1) that is an offset signal (e.g., a difference signal between an output signal of the first amplifier 214 and a reference voltage (Vref)) based on the reference voltage (Vref) that the controller 205 provides to provide the first ADC signal (ADC1) to the controller (205). The first ADC signal, which is an analog-to-digital conversion signal, may a digital signal corresponding to an analog signal which is the output signal of the first amplifier 214.

The second amplifier 216 may amplify a voltage across the second shunt resistor 282 (or the current flowing through the second shunt resistor 282) to provide the amplified voltage to the second offset circuit 215. For example, the second amplifier 216 may be realized as an operational amplifier (OP-amp), and the second amplifier 216 may also be referred to as a shunt current operational amplifier.

The second offset circuit 215 may output the second ADC signal (ADC2) that is an offset signal (e.g., a difference signal between an output signal of the second amplifier 216 and the reference voltage (Vref)) based on the reference voltage (Vref) that the controller 205 provides to provide the second ADC signal (ADC2) to the controller 205. The second ADC signal, which is an analog-to-digital conversion signal, may a digital signal corresponding to an analog signal which is the output signal of the second amplifier 216.

The third amplifier 218 may amplify a voltage across the third shunt resistor 283 (or the current flowing through the third shunt resistor 283) to provide the amplified voltage to the third offset circuit 217. For example, the third amplifier 218 may be realized as an operational amplifier (OP-amp), and the third amplifier 218 may also be referred to as a shunt current operational amplifier.

The third offset circuit 217 may output the third ADC signal (ADC3) that is an offset signal (e.g., a difference signal between an output signal of the third amplifier 218 and the reference voltage (Vref)) based on the reference voltage (Vref) that the controller 205 provides to provide the third ADC signal (ADC3) to the controller 205. The third ADC signal, which is an analog-to-digital conversion signal, may a digital signal corresponding to an analog signal which is the output signal of the third amplifier 218.

The protection circuit 211 may convert the PWM signal to a parallel signal to provide the converted parallel signal to the driver 212 in response to the PWM signal and the SPI signal. The protection circuit 111 may analyze the PWM signal and the SPI signal to detect an error. When there is the error, the protection circuit 111 may transmit an error signal to the controller 205. In response to the error signal, the controller 205 may transmit a corrected PWM signal and a corrected SPI signal to the protection circuit 211.

In response to the converted parallel signal, the driver 212 may generate the gate signal (GH_A, GL₁₃ A, GH_B, GL_B, GH_C, or GL_C) that turns on each of transistors 241, 242, 243, 244, 245, and 246 included in the inverter 240. The inverter 240 may generate an alternating current signal for driving a motor 260 in response to the gate signal.

The inverter 240 may include a plurality of transistors, and may convert a power supply voltage (PVDD) that is a direct current (DC) to an alternating current (AC) voltage. For example, the transistor may be an N-channel metal oxide semiconductor field effect transistor (MOSFET) (i.e., an NMOS transistor) or an insulated gate bipolar transistor (IGBT).

As described above, the device 200 may combine three shunt resistors with the source of a low-side field effect transistor (FET) of the inverter 240 to measure current Ia that is the first current, current Ib that is the second current, and current Ic that is the third current, thereby estimating the rotor position of the motor 260. Current Ia, current Ib, and current Ic may be included in the motor driving current.

The device 200 may differentiate a change in the rotor position to detect rotational speed of the motor 260, may compare the detected speed of the motor with the target speed of the motor 260 to get speed deviation and calculate the 3-phase voltage vector corresponding to the speed deviation, and may supply a pulse width modulation (PWM) voltage corresponding to the calculated 3-phase voltage vector to the inverter 240, thereby generating the motor phase current flowing through the stator coil of the motor 260 as a sine wave. The motor 260 may be driven by the sine wave.

When a duty cycle of the PWM signal is output as at least 95%, a phase current detection period of the motor 260 may be shortened, thereby not detecting the phase current. For example, when the duty cycle of the PWM signal regarding phase current Ia is output as 95% or more, the phase current Ia may be obtained by using lb and Ic that are phase currents and Ia=−Ib−Ic that is Kirchhoff equation. In more detail, when one of the first current, the second current, and the third current is not detected by being detected by the controller 205 that the duty cycle of the PWM signal corresponding to one of the first current, the second current, and the third current is greater than or equal to a threshold value (e.g., 95% or more), the controller 205 uses Kirchhoff equation (i.e., Kirchhoff's current law) to calculate the current that is not detected. Therefore, the device 200 may control the duty cycle of the PWM signal to be 100%, thereby increasing voltage utilization range and efficiency of the motor 260.

The device 200 may include a logic (or a program) that measures three phase currents which flows through three shunt resistors to diagnose (or detect) disconnection of the motor coil or an open-circuit state of a circuit including the shunt resistor. In more detail, the controller 205 may detect disconnection in the stator coil included in the motor 260 or an open-circuit state of a circuit including the first shunt resistor and the second shunt resistor and the third shunt resistor based on the first current, the second current, and the third current. For example, when the first current is detected as 0, the controller 205 may determine that the stator coil or the first shunt resistor 281 is broken.

The device 200 may use the three shunt resistors 281, 282, and 283 to measure the phase currents and perform supersaturation driving by using the measured phase currents, thereby increasing output of the motor up to 100%. The supersaturation driving may be to supply a maximum value of the phase current to the motor.

The device 200 may be a circuit that drives the motor 260 by combining the three shunt resistors with the source of the FET of the inverter 240 to measure the three phase currents (or phase current vectors) that are Ia, Ib, and Ic.

The device 200 may perform a Clarke transform on Ia and Ib that are the measured phase currents to calculate Iα and Iβ and may use the calculated Iα and Iβ to estimate a current position vector of the rotor.

The device 200 may measure a current cycle of Ia, Ib, or Ic to calculate rotational speed of the motor 260 and may perform a Park transform by using Iα and Iβ to calculate Id and Iq.

The device 200 may calculate a speed difference between the target speed of the motor 260 and a current speed of the motor 260 by using a proportional-integral (P1) controller, may calculate Iq and Iqref by using the PI controller to generate Vsd signal and Vsq signal that are voltage component vectors, and may perform an inverse Park transform on the generated Vsd signal and Vsq signal to calculate three phase voltage components.

The device 200 may perform a space vector modulation (SVM) for the calculated voltage components to generate three-phase PWM signals and provide the generated PWM signals to the driver 212 that is a gate driver integrated circuit (IC). In response to the three phase PWM signals, the inverter 240 that the power supply voltage (PVDD) is applied to may generate three phase voltages to provide the generated three phase voltages to the motor 260. The power supply voltage (PVDD) may be supplied by a main power device. A current may be generated by the supplied voltage and the generated current may be detected by the shunt resistor.

As described above, a closed loop circuit may be formed so that speed control of the motor 260 may be performed. For example, when a duty cycle of the PWM signal corresponding to phase current Ib becomes 95% or more, the device 200 may calculate the phase current Ib by using Ia and Ic that are phase currents and Kirchhoff equation, thereby controlling the drive of the motor 260. Therefore, even when the duty cycle of the PWM signal becomes 95% or more, the motor may be continuously driven.

When there occurs disconnection in a coil circuit of the motor 260, a state of the motor currents may become an unbalanced state. The device 200 may measure the three phase currents separately to comparing the phase currents, thereby determining the unbalanced state. In other words, the device 200 may perform a coil open logic which determines that the coil circuit of the motor 260 is broken when the state of the motor currents is determined as the unbalanced state.

The components, “˜unit”, block, or module which are used in the present exemplary form may be implemented in software such as a task, a class, a subroutine, a process, an object, an execution thread, or a program which is performed in a predetermined region in the memory, or hardware such as a field programmable gate array (FPGA) or an application-specific integrated circuit (ASIC), and may be performed with a combination of the software and the hardware. The components, ‘˜part’, or the like may be embedded in a computer-readable storage medium, and some part thereof may be dispersedly distributed in a plurality of computers.

As set forth above, exemplary forms have been disclosed in the accompanying drawings and the specification. Herein, specific terms have been used, but are just used for the purpose of describing the present invention and are not used for qualifying the meaning or limiting the scope of the present invention, which is disclosed in the appended claims. Therefore, it will be understood by those skilled in the art that various modifications and equivalent exemplary forms are possible from the present disclosure. Accordingly, the actual technical protection scope of the present disclosure must be determined by the spirit of the appended claims.

### DESCRIPTION OF SYMBOLS

105: controller

110: driver circuit

140: inverter

181: first shunt resistor

182: second shunt resistor

205: controller

210: driver circuit

240: inverter

281: first shunt resistor

282: second shunt resistor

283: third shunt resistor

What is claimed is:

1. A device for controlling a motor, comprising:
an inverter configured to drive the motor, the inverter comprising a first low-side transistor and a second low-side transistor;
a first shunt resistor which is connected to a source of the first low-side transistor included in the inverter;
a second shunt resistor which is connected to a source of the second low-side transistor included in the inverter; and
a controller configured to control the inverter based on a first current flowing through the first shunt resistor and a second current flowing through the second shunt resistor.

2. The device of claim 1, wherein the controller is configured to utilize the first current and the second current to estimate a position of a rotor included in the motor, to differentiate a change in the position to detect a speed of the motor, to compare the detected speed of the motor with a target speed of the motor to determine speed deviation and to calculate a 3-phase voltage vector corresponding to the speed deviation, and to provide a pulse width modulation (PWM) signal corresponding to the calculated 3-phase voltage vector to the inverter.

3. A device for controlling a motor, comprising:
an inverter configured to drive the motor, the inverter comprising a first low-side transistor, a second low-side transistor, and a third low-side transistor;
a first shunt resistor which is connected to a source of the first low-side transistor included in the inverter;
a second shunt resistor which is connected to a source of the second low-side transistor included in the inverter;
a third shunt resistor which is connected to a source of the third low-side transistor included in the inverter; and
a controller configured to control the inverter based on a first current flowing through the first shunt resistor, a second current flowing through the second shunt resistor, and a third current flowing through the third shunt resistor.

4. The device of claim 3, wherein the controller is configured to utilize the first current and the second current and the third current to estimate a position of a rotor included in the motor, to differentiate a change in the position to detect a speed of the motor, to compare the detected speed of the motor with a target speed of the motor to determine speed deviation and to calculate a 3-phase voltage vector corresponding to the speed deviation, and to provide a pulse width modulation (PWM) signal corresponding to the calculated 3-phase voltage vector to the inverter.

5. The device of claim 3, wherein the controller is configured to detect disconnection in a stator coil included in the motor or an open-circuit state of a circuit including the first shunt resistor and the second shunt resistor and the third shunt resistor based on the first current, the second current, and the third current.

6. The device of claim 3, wherein, when one of the first current, the second current, or the third current is not detected by being detected that a duty cycle of a pulse width modulation (PWM) signal corresponding to one of the first current, the second current, and the third current is greater than or equal to a threshold value, the controller is configured to utilize a Kirchhoff equation to calculate the current that is not detected.
